(19) United States
(12) Patent Application Publication
(10) Pub. No.: US 2026/0154539 A1
(43) Pub. Date: Jun. 4, 2026

(54) METHODS FOR QUANTIZING, TRAINING AND USING A DEPTHWISE SEPARABLE CONVOLUTIONAL NEURAL NETWORK

(71) Applicant: Robert Bosch GmbH, Stuttgart (DE)

(72) Inventors: Lukas Meiner, Weissach (DE); Alexandru Paul Condurache, Renningen (DE); Jens Eric Markus Mehnert, Malmsheim (DE)

(21) Appl. No.: 19/400,651

(22) Filed: Nov. 25, 2025

(30) Foreign Application Priority Data
Dec. 4, 2024 (DE) 10 2024 211 602.5

(51) Int. Cl. G06N 3/0495; G06N 3/0464

(52) U.S. Cl. CPC G06N 3/0495; G06N 3/0464

(57) ABSTRACT

Methods for quantizing, training and using a depthwise separable convolutional neural network. The network layers include one or more pointwise convolution layers, which are suitable for performing pointwise convolutions and in each case comprise a plurality of pointwise convolution layer weights, and one or more depthwise convolution layers, which are suitable for performing depthwise convolutions and in each case comprise a plurality of pointwise convolution layer weights. The quantization method includes quantizing the plurality of pointwise convolution layer weights to a plurality of quantized pointwise convolution layer weights in a first discrete range and quantizing the plurality of pointwise convolution layer weights to a plurality of quantized pointwise convolution layer weights in a second discrete range, wherein the first discrete range has a strictly lower cardinality than the second discrete range.

### CROSS REFERENCE

The present application claims the benefit under 35 U.S.C. § 119 of Germany Patent Application No. DE 10 2024 211 602.5 filed on Dec. 4, 2024, which is expressly incorporated herein by reference in its entirety.

### FIELD

The present invention relates to a computer-implemented quantization method for a depthwise separable convolutional neural network. The present further relates to a computer-implemented method for training a depthwise separable convolutional neural network. The present invention further relates to a computer-implemented method for using a depthwise separable convolutional neural network on a device. The subject matter disclosed herein further relates to a volatile or non-volatile computer-readable medium comprising data representing a computer program, wherein the computer program comprises instructions in order to cause a processor system to carry out one of the methods, and a processor system comprising a memory and one or more processors, wherein the memory comprises instructions in order to cause the one or more processors to carry out one of the methods.

### BACKGROUND INFORMATION

Convolutional neural networks (CNNs) are crucial components in many real-world application tasks, such as computer vision, object recognition, image processing, image recognition, image classification, medical imaging, image generation and other image analysis applications. For example, a CNN can be trained to recognize road users in camera images. Once trained, the CNN can then be used in an autonomous vehicle for object recognition tasks, for example, in order to recognize road users such as pedestrians near the car and make it possible for the car to react to these other road users when required, for example by steering, braking, or triggering a warning.

CNNs typically comprise one or more convolution layers, which are suitable for performing convolutions on a feature input, for example an image input. The feature input can comprise a size of F₁×F₂×M, where F₁, F₂ represent feature dimensions, and M represents a number of input channels. For example, in the case of a general RGB image input M=3. In general, convolution layers comprise a convolution kernel that consists of a number, such as N, of filters. These filters generally have a size of K₁×K₂×M, where K₁, K₂ represent kernel dimensions, and M corresponds to the number of input channels of the feature input. In the general CNN setting, the number of parameters in the convolution kernel can then be equal to the number of filters multiplied by the size of these filters, i.e., K₁ K₂MN, and the number of computations can be K₁K₂MNF₁F₂.

Depthwise separable CNNs (DSCNNs) are CNNs that are provided with a typical structure. While a general CNN comprises one or more convolution layers that are suitable for performing convolutions, DSCNNs typically comprise one or more pointwise convolution (PWC) layers and one or more depthwise convolution (DWC) layers, and the performance of general convolutions is divided between performing pointwise convolutions by the PWC layers and performing depthwise convolutions by the DWC layers.

Due to this structure, the computational requirements of the network are generally reduced as follows, making DSCNNs particularly useful for deployment on resource-constrained and/or mobile devices, such as edge devices.

In depthwise convolution (DWC), a convolution kernel can be split into a single-channel form. A separate filter can be created for each channel of input data. When repeating the feature input of a general CNN as above, the input data can comprise M channels. Using the same notation as above, all of the M separate filters can have a size of K₁×K₂×1. Then, separate convolution operations can be performed for each channel separately, wherein the separate channels are used, and the output comprises a dimensionality that is equal to the number of channels in the input data. In the DWC setting, the number of parameters in the convolution kernel can then correspond to the number of filters multiplied by the size of these filters, i.e., K₁K₂M, and the number of computations can be K₁K₂MF₁F₂.

In general, after a DWC, pointwise convolutions (PWCs) can be used to combine DWC outputs into a new feature map in order to reduce the output dimensionality of the DWC. PWCs generally comprise 1×1 convolutions. Using the same notation as above, a number of N filters of size 1×1×M can be used in the PWCs, wherein M can correspond to the number of channels in the DWC and N to the number of filters that a general CNN would use. In the PWC setting, the number of parameters in the convolution kernel can then be equal to the number of filters multiplied by the size of these filters, i.e., MN and the number of computations can be MNF₁F₂.

Since the PWCs can combine the feature maps of the DWCs and generate new feature maps based on the number of convolution kernels, the output of the combined DWCs and PWCs can be equivalent to the output of a conventional convolution layer in a general CNN with the same parameters. The number of parameters for the combined DWC and PWC layers can then be (K₁K₂+N)M and the number of computations can be (K₁K₂+N)MF₁F₂. The ratio of the number of parameters and the ratio of the number of computations can then both be:

$$\frac{\# ( parameters DSCNN )}{\# ( parameters general CNN )} = \frac{\# ( calculations DSCNN )}{\# ( calculations general CNN )} = \frac{1}{N} + \frac{1}{{K}_{1} {K}_{2}}$$

Due to their structure, DSCNNs are generally parameter-efficient and computationally inexpensive, and represent an alternative to kernels of larger CNNs. Examples of DSCNNs are MobileNets (Howard et al. (2017), “MobileNets: Efficient Convolutional Neural Networks for Mobile Vision Applications,” Sandler et al. (2018), “MobileNetV2: Inverted Residuals and Linear Bottlenecks,” and Howard et al. (2019), “Searching for MobileNetV3”), EfficientNet (Tan and Le (2019), “EfficientNet: Rethinking Model Scaling for Convolutional Neural Networks,” and (2021) “EfficientNetV2: Smaller Models and Faster Training”) and ConvNext (Liu et al. (2022), “A ConvNet for the 2020s,” and Woo et al. (2023), “ConvNext V2: Co-Designing and Scaling ConvNets with Masked Autoencoders”). DSCNNs generally perform well in the above-mentioned application tasks, such as computer vision, and due to their structure, they usually do not require as many computational resources as general CNNs. The trade-off between task performance and resource requirements is therefore generally desirable. However, the developed models using DSCNNs are generally becoming more and more complicated, due to which the computational costs of DSCNNs are increasing, resulting in high energy consumption and environmental impact. This is particularly problematic if an application task, as mentioned above, is carried out with a complicated model that uses DSCNNs on a resource-constrained and/or mobile device, such as an edge device. For example, the device may have only a limited computational budget for carrying out the application tasks, there may be restrictions in terms of the number of computations that can be carried out per unit of time, the memory available to temporarily store data during the application tasks may be limited, the computing power and/or energy resources, such as battery capacities, may be limited and/or restricted, etc. The budget may also be dynamic, i.e., it may change over time, e.g., due to other processes that are carried out consecutively with the disturbance. In some examples, it may not be known in advance how much computational budget is available at a certain point in time. This can be problematic because evaluating complex DSCNNs can be expensive in terms of computational costs. It may therefore be a worthwhile goal to minimize the memory size and/or computational costs of convolutional neural networks while maintaining a desired performance of the convolutional neural network in the application tasks.

Quantization methods are conventional methods for compressing CNNs, by which the memory size and energy costs of the models using the CNNs are reduced, while maintaining the desired accuracy. The computations in a CNN are generally reduced from a floating-point format to integer operations. However, there are limitations in the compression capabilities of quantization methods while maintaining model accuracy. Quantization to bit widths smaller than 8 bits generally affects the accuracy of a typical CNN model, thereby reducing the task performance of the model. In order to account for the reduction in task performance, lower bit-width quantization methods generally require extensive multi-stage training methods in which the bit width of a model is gradually reduced in a plurality of stages. However, these training methods are extensive and cost-intensive in relation to time and/or computations, are often based on knowledge distillation from larger teacher models, and/or require a specific, customized model architecture. Furthermore, in such an inference phase, a quantized DSCNN model can be deployed on a resource-constrained device without native hardware support. For example, the device can be an edge device. The device can comprise hardware, such as general-purpose edge hardware, which may not support user-defined operations typical of the inference phase. For these reasons, the training and inference methods are generally not suitable for general CNN and/or DWSCNN applications, for example, on general resource-constrained devices.

A disadvantage of existing methods for quantizing DWSCNNs is that they either rely on the application of an extensive training method that is not suitable for many DSCNN applications or cannot achieve lower bit widths beyond 8-bit weights while maintaining the desired accuracy.

### SUMMARY

It would be advantageous to improve the quantization methods for compressing DSCNNs while maintaining the accuracy that is suitable for use on resource-constrained devices in a suitable manner.

According to a first aspect of the present invention, a computer-implemented quantization method for a depthwise separable convolutional neural network is provided, wherein the depthwise separable convolutional neural network comprises a plurality of network layers, wherein each of the plurality of network layers comprises a plurality of network weights, wherein the plurality of network layers comprises:
one or more pointwise convolution layers, which are suitable for performing pointwise convolutions, wherein each of the one or more pointwise convolution layers comprises a plurality of pointwise convolution layer weights, and
one or more depthwise convolution layers, which are suitable for performing depthwise convolutions, wherein each of the one or more depthwise convolution layers comprises a plurality of depthwise convolution layer weights.

According to an example embodiment of the present invention, the quantization method comprises quantizing the plurality of network weights, comprising:
quantizing the plurality of pointwise convolution layer weights to a plurality of quantized pointwise convolution layer weights in a first discrete range, and
quantizing the plurality of depthwise convolution layer weights to a plurality of quantized depthwise convolution layer weights in a second discrete range,
   wherein the first discrete range has a strictly lower cardinality than the second discrete range.

According to a further aspect of the present invention, a volatile or non-volatile computer-readable medium comprises data that represent a computer program, wherein the computer program comprises instructions that cause a processor system to perform one of the methods of the present invention described in this specification.

According to a further aspect of the present invention, a processor system is provided, wherein the processor system comprises a memory and one or more processors, wherein the memory comprises instructions that cause the one or more processors to perform one of the methods described in this specification.

The above measures contain quantizations of pointwise convolution layer weights (PWC) and depthwise convolution layer weights (DWC), wherein the quantizations differ from one another. The quantizations differ from one another in the sense that the PWC layer weights are quantized to weights in a first discrete range and the DWC layer weights are quantized to weights in a second discrete range, wherein the first discrete range has a strictly lower cardinality than the second discrete range.

The inventors have found that DSCNNs, due to their structure and architectural design, are suitable for applying different quantizations to the different types of convolution layers in the DSCNNs. Furthermore, the different operations performed by the different types of convolution layers, namely DWCs and PWCs, contribute differently to the total cost in time and computations, as a result of which the computation costs are unevenly distributed. For example, in the MobileNetV2 model, the DWCs can account for up to 1.9% of the parameters and 33.6% of the energy costs of the model, while the PWCs can account for 61.2% of the parameters and 66.1% of the energy costs of the model. This aspect makes it worthwhile to quantize the weights in the PWC layer and the DWC layer to different bit widths. The first discrete range, which has a lower cardinality, corresponds to a smaller bit width than the bit width of the second discrete range. If the weights of the PWC layer that correspond to the expensive PWCs are quantized more strongly, namely to a smaller bit width, than the weights of the DWC layer that correspond to the DWCs, the weights of the DWC layer can remain at a higher bit width, as a result of which the corresponding parts in the DSCNN can still operate with the desired accuracy.

The above measures achieve compression of a DSCNN, which reduces its memory size and energy costs. This is achieved by a quantization method that quantizes PWC layers, which are generally expensive, more heavily than DWC layers, for which it is important to maintain their accuracy and performance. This quantization method is particularly suitable for and can be used on resource-constrained devices, since the use of computing resources can be improved and optimized without the need for an extensive training method. The suitability of quantization methods for resource-constrained devices can be further ensured by lower memory requirements and suitability for general hardware on such devices.

Optionally, the first discrete range comprises a cardinality of 2 or 3. Such a first discrete range can correspond to the PWC layer weights, which comprise binary or ternary weights. Optionally, the second discrete range comprises a cardinality in the range of 3 to 256, for example 16. Such a second discrete range can correspond to the weights of the DWC layer, which can comprise weights from 2 to 8 bits, for example 4 bits. Optionally, the first discrete range comprises a first cardinality and the second discrete range comprises a second cardinality, wherein the first cardinality multiplied by fifty is lower than the second cardinality. For example, by maintaining 8-bit DWCs and reducing PWCs to ternary weights, all computations can be kept in int8 format. Int8 additions generally enjoy broad support across hardware platforms and eliminate costly multiplications, in contrast to int4 or int2 operations on which existing methods may rely. By using an 8-bit width, the accuracy of task performance is generally not affected, which is important for the DWC operations. For models based on 8-bit integer operations, a Pareto frontier for the energy consumption and memory size of models based on 8-bit integer operations can be improved.

Optionally, the plurality of network layers further comprises one or more activation layers, wherein each of the one or more activation layers comprises an activation function, wherein each of the one or more activation layers is suitable for performing an activation on an input of the particular activation layer, wherein the activation comprises applying a particular activation function to an input, and wherein the method further comprises adapting one or more activation functions of the one or more activation layers to one or more adapted activation functions, wherein each of the one or more adapted activation functions is different from a particular activation function from the one or more activation functions of the one or more activation layers. Optionally, the one or more activation functions comprise non-parametric activation functions, such as a ReLU activation function, a ReLU activation function with an upper limit, a hardswish activation function, a sign activation function or a LeakyReLU activation function. Furthermore, the one or more adapted activation functions can comprise parametric activation functions, such as a PReLU activation function. Replacing ReLU-like and/or non-parametric activations with a parametric activation function, such as PReLU, can be a parameter-efficient way to improve model performance. Parameters used in the parameterization of the PReLU activation function can improve model performance more than when such parameters are used in PWC layer weights or DWC layer weights.

In a further aspect of the present invention, a computer-implemented method for training a depthwise separable convolutional neural network can be provided, wherein the depthwise separable convolutional neural network comprises a plurality of network layers, wherein each of the plurality of network layers comprises a plurality of network weights, wherein the plurality of network layers comprises:

-one or more pointwise convolution layers, which are suitable for performing pointwise convolutions, wherein each of the one or more pointwise convolution layers comprises a plurality of pointwise convolution layer weights,
one or more depthwise convolution layers, which are suitable for performing depthwise convolutions, wherein each of the one or more depthwise convolution layers comprises a plurality of depthwise convolution layer weights, and
one or more activation layers, wherein each of the one or more activation layers is suitable for performing an activation on an input of the particular activation layer,
wherein the method comprises:
iteratively training the plurality of network weights on a training data set, wherein the training data set comprises a plurality of input samples, wherein the training for an input sample comprises:
during a forward pass,
simulating a quantization step of the network layers using a quantization method according to the present invention, wherein the plurality of network weights are quantized to a plurality of quantized network weights,
quantizing activations of the input sample, which are performed by one or more activation layers, to quantized activations in a discrete range,
dequantizing the plurality of quantized network weights and the quantized activations by rescaling the plurality of quantized network weights and rescaling the quantized activations, resulting in a plurality of dequantized network weights and dequantized activations,
during a backward pass, performing a gradient estimation using the dequantized network weights and the dequantized activations,
based on the gradient estimation, adapting the dequantized network weights and the dequantized activations,
providing the trained depthwise separable convolutional neural network for inference.

The above-mentioned measures can make possible a quantization-aware training method based on a quantization method according to the present invention. Due to such quantization-aware training, models with the desired accuracy can be achieved, while keeping the overall computational costs low. Using a quantization method according to the present invention, the network weights can be quantized and/or dequantized accordingly. The network weights can be updated using gradient descent, which can be a standard gradient descent.

Optionally, the training method further comprises, before providing the trained depthwise separable convolutional neural network for inference, quantizing the plurality of network weights using a quantization method according to the present invention, resulting in a plurality of quantized network weights, and maintaining the plurality of quantized network weights during inference. Converting the network weights into fixed, quantized weights after the training part of the training method can make efficient inference possible.

In a further aspect of the present invention, a computer-implemented method is provided for using a depthwise separable convolutional neural network on a device having limited computing resources, a mobile device and/or an autonomous device, such as an autonomous robot and/or an autonomous vehicle, in order to perform one or more of computer vision, object recognition, image processing, image recognition, image classification, medical imaging and/or image generation, wherein the depthwise separable convolutional neural network has been trained using a training method according to the present invention.

The above-mentioned measures can make possible an inference method based on a training method according to the present invention. Since the training method according to the present invention is based on a quantization method, such an inference method can ensure that the trained DSCNN is optimized both in terms of performance for the application tasks mentioned and in terms of suitability for use on the device on which the DSCNN is used.

It will be apparent to a person skilled in the art that two or more of the above embodiments, implementations, and/or optional aspects of the present invention can be combined in any manner deemed useful.

Modifications and variations of any device, system, network, computer-implemented method and/or computer-readable medium that correspond to the described modifications and variations of another of these entities may be made by a person skilled in the art based on the present description.

### BRIEF DESCRIPTION OF THE DRAWINGS

Further details, aspects and embodiments are described, by way of example only, with reference to the figures. Elements in the figures are shown for simplicity and clarity and are not necessarily drawn to scale. In the figures, elements that correspond to elements already described may have the same reference numbers.

FIG. 1A schematically shows an example embodiment of a device that comprises a depthwise separable convolutional neural network, according to an example embodiment of the present invention.

FIG. 1B schematically shows an example of an application of a system that comprises a depthwise separable convolutional neural network within an autonomous vehicle, according to an example embodiment of the present invention.

FIG. 2A schematically shows an example embodiment of a depthwise separable convolutional neural network, according to the present invention.

FIG. 2B schematically shows an example embodiment of a depthwise separable convolutional neural network after quantization, according to the present invention.

FIG. 3 schematically shows part of a training step in an example embodiment of a method for training a depthwise separable convolutional neural network, according to the present invention.

FIG. 4 schematically shows an example embodiment of a quantization method for a depthwise separable convolutional neural network, according to the present invention.

FIG. 5 schematically shows an example embodiment of a method for training a depthwise separable convolutional neural network, according to the present invention.

FIG. 6 schematically shows an example embodiment of a method for using a depthwise separable convolutional neural network, according to the present invention.

FIG. 7A schematically shows a computer-readable medium having a writable part that comprises a computer program according to one example embodiment of the present invention.

FIG. 7B is a schematic representation of a processor system according to one example embodiment of the present invention.

### LIST OF REFERENCE SIGNS

The following list of reference signs and abbreviations is provided to facilitate the interpretation of the figures and is not to be construed as a limitation of the present invention.
10 Input image
20 Quantization step
21, 21′ Pointwise convolution layer weights
21.1, 21.1′ Quantized pointwise convolution layer weights
21.2, 21.2′ Dequantized pointwise convolution layer weights
22 Depthwise convolution layer weights
22.1 Quantized depthwise convolution layer weights
22.2 Dequantized depthwise convolution layer weights
23, 23′ Activation functions
23.1, 23.1′ Adapted activation functions
24, 24′ Activations
24.1, 24.1′ Quantized activations
24.2, 24.2′ Dequantized activations
30 Dequantization step
31, 31′ Input samples
40 Gradient estimation
100 System
110 Device
111 Processor system
112 Memory
113 Communication interface
114 Autonomous vehicle
115 Image sensor
116 Pedestrian
200, 201, 202 Depthwise separable convolutional neural network
210, 210′, 211, 211′ Pointwise convolution layers
220, 221 Depthwise convolution layers
230, 230′, 231, 231′ Activation layers
240, 241 Network layer
300 Part of a training step
301 Forward pass
302 Backward pass
310 Training data set
400 Quantization method for a depthwise separable convolutional neural network
410 Quantizing network weights
411 Quantizing pointwise convolution layer weights
412 Quantizing depthwise convolution layer weights
420 Adapting activation functions
500 Method for training a depthwise separable convolutional neural network
501 Training network weights
502 Providing a trained network for inference
503 Quantizing network weights
504 Maintaining quantized network weights
510 Forward pass
511 Simulating a quantization step
512 Quantizing activations
520 Dequantizing quantized network weights and activations
530 Backward pass
531 Performing a gradient estimation
540 Adapting dequantized network weights and activations
600 Method for using a depthwise separable convolutional neural network
601 Using a trained depthwise separable convolutional neural network
1000 Optical storage device Memory card
1020, 1021 Stored data
1110 Subsystems or components
1120 Processing subsystem
1122 Memory
1124 Dedicated integrated circuit
1126 Communication interface
1130 Connection
1140 Processor system

### DETAILED DESCRIPTION OF EXAMPLE EMBODIMENTS

While the subject matter of the present invention disclosed herein can be embodied in many different forms, one or more specific embodiments are represented in the figures and will be described in detail herein, wherein it is understood that this disclosure is to be considered as illustrative of the principles of the subject matter of the present invention disclosed herein and is not intended to limit it to the specific embodiments shown and described.

For better understanding, elements of embodiments in operation are described below. However, it will be clear that the respective elements are arranged to carry out the functions described.

Furthermore, the subject matter of the present invention disclosed herein is not limited only to the embodiments, but also comprises any other combination of features described herein.

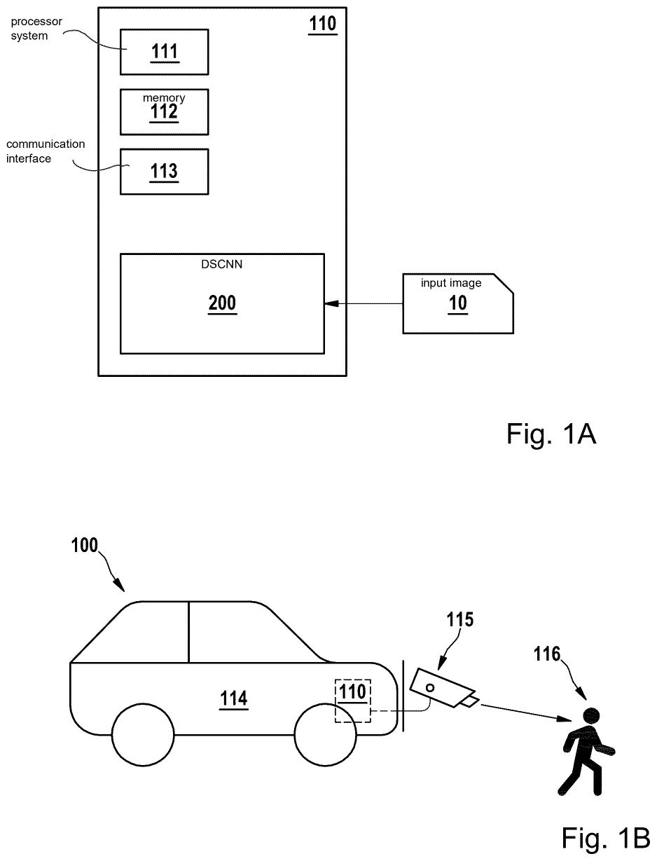

FIG. 1A schematically shows an embodiment of a system 100, which comprises a device 110 that comprises a depthwise separable convolutional neural network (DSCNN) 200. The DSCNN 200 can use an image 10 as input. The DSCNN 200 can be a trained neural network. The DSCNN 200 can be suitable for carrying out one or more application tasks. The one or more application tasks can perform one or more of computer vision, object recognition, image processing, image recognition, image classification, medical imaging and image generation. The DSCNN 200 can comprise one or more models for computer vision, object recognition, image processing, image recognition, image classification, medical imaging, image generation and/or other image analysis applications, and/or be contained in one or more of these models.

The system 100 can comprise a processing subsystem 111, a memory 112 and a communication interface 113. The system 110 can access input data, such as sensor data, obtained from one or more sensors, such as radar data, lidar data, ultrasound data or image sensor data. For example, the input data can be retrieved from a data memory 112 via the communication interface 113. The data memory 112 can be a local memory of the system 110, e.g., a local hard disk or local memory. However, the memory 112 can also be a non-local memory, e.g., a network-accessible memory such as cloud storage. In other examples, the system 110 can access the input data directly from one or more sensors, e.g., without storing the input data at least temporarily on a data memory 112. In such examples, the communication interface 113 can be a sensor interface to the one or more sensors.

The processing subsystem 130 can be suitable for carrying out an application task as mentioned above using a DSCNN 200. The DSCNN 200 can comprise one or more input layers, a plurality of intermediate layers and one or more output layers in order to generate an output of the DSCNN 200.

When carrying out an application task using a DSCNN, whose network may be complex, a system such as the system 100 typically has only a limited computational budget for carrying out the application task. For example, the device 110 can be a resource-constrained device that has limitations in terms of memory and/or computing resources, a mobile device, and/or an autonomous device such as an autonomous robot and/or an autonomous vehicle. In some examples, it may not be known in advance how much computational budget is available at a certain point in time.

In general, the system 110 can communicate with an external memory, input devices, output devices and/or one or more sensors, for example, via a computer network. The computer network can be the Internet, an intranet, a LAN, a WLAN, etc. The computer network can be the Internet. The system 110 can comprise a communication interface 113, which is arranged so that it communicates within or outside the system as needed. For example, the communication interface 113 can be a wired interface, e.g., an Ethernet interface, an optical interface, etc., or a wireless interface, e.g., a radio interface, e.g., a Wi-Fi, 4G or 5G radio interface.

In general, the system 110 can be implemented in or as a processor system, e.g., using one or more processor circuits, e.g., microprocessors. The processor system can comprise a processing subsystem that may be implemented in whole or in part in computer instructions stored on the system 110, e.g., in an electronic memory of the system 110, and executable by a microprocessor of the system 110. In hybrid embodiments, the processing subsystem can be implemented partially in hardware, e.g., as coprocessors, e.g., machine learning coprocessors, and partially in software stored and executed on the system 110. Parameters of the machine learning model and/or input data can be stored locally on the system 110 or in cloud storage. In general, a memory can be distributed across a plurality of submemories. The memory can be, in whole or in part, an electronic memory, a magnetic memory, etc. For example, the memory can have a volatile and a non-volatile part. Part of the memory can be write-protected. The system 110 can have a user interface that can comprise conventional elements such as one or more buttons, a keyboard, a display, a touchscreen, etc. The user interface can be arranged so that user interaction for configuring the system, applying the trained machine learning model to input data, etc., is made possible.

In general, the system 110 can be implemented in a single device. Typically, the system comprises a microprocessor that executes appropriate software stored in the system; such software may, for example, be downloaded and/or stored in a corresponding memory, e.g., in a volatile memory such as RAM or a non-volatile memory such as flash. Alternatively, the system can be implemented in whole or in part in programmable logic, e.g., as a field-programmable gate array (FPGA). The system can be implemented in whole or in part as a so-called application-specific integrated circuit (ASIC), e.g., as an integrated circuit (IC) that is adapted for its particular use. For example, the circuits can be implemented in CMOS, e.g., using a hardware description language such as Verilog, VHDL, etc. In particular, the system 110 can comprise circuits for evaluating machine learning models, such as neural networks.

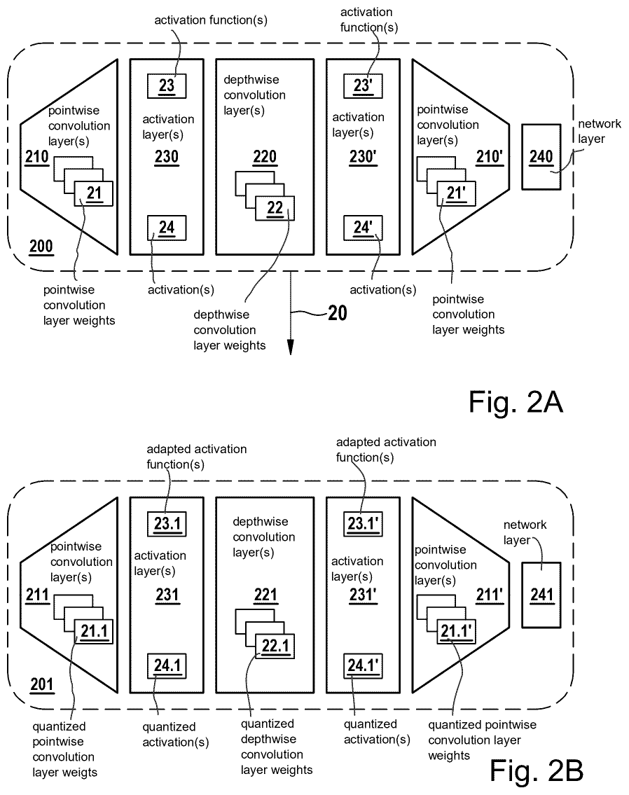

FIG. 1B schematically shows an application example of a device 110, which comprises a DSCNN 200, in an autonomous vehicle 114. The device 110 can be suitable for performing object recognition in the autonomous vehicle 114 with the aid of the DSCNN 200. The application task of object recognition can consist in generating markings, for example bounding boxes. Such markers can mark the positions of objects and their dimensions in a 2D image, such as an image input received from an image sensor, and classify their contents. In this implementation, the DSCNN 200 may have been trained to recognize road users, such as pedestrians 116, in camera images that have been obtained from an image sensor, such as a camera 115. After training, the trained DSCNN 200 can be used by the device 100 in the car 114 for object recognition. The camera images detected by the camera 115 can be temporarily stored in the data memory 112, which is connected to the communication interface 113. The processing subsystem 111 can then perform classification using the stored camera images as input, which allows the car 114 to recognize the road users 116 in the vicinity of the car 114. In some examples, the device 110 can be suitable for controlling one or more actuators in the car 114 or other computer-controlled machine, for example via an actuator interface that can be part of the device 110 or external thereto. By controlling one or more actuators, the car 114 can be controlled so that it reacts correctly to these other road users 116 when required, for example by steering, braking or triggering a warning. While the above specifically relates to a car, it is apparent that the device 110 can control any other computer-controllable machine via an actuator interface. FIG. 2A schematically shows an embodiment of a depthwise separable convolutional neural network 200. A depthwise separable convolutional neural network (DSCNN) 200 is a convolutional neural network (CNN) that is provided with a typical structure. DSCNNs generally provide a parameter-efficient and computationally inexpensive alternative to regular CNNs, which use dense convolutions with large kernel sizes. The DSCNN 200 can comprise a plurality of network layers 210, 210′, 220, 230, 230′, 240. Each of the plurality of network layers 210, 210′, 220, 230, 230′, 240 can comprise a plurality of network weights 21, 21′, 22. The plurality of network layers 210, 210′, 220, 230, 230′, 240 can comprise one or more pointwise convolution layers 210, 210′. The one or more pointwise convolution layers 210, 210′ can be suitable for performing pointwise convolutions (PWCs). For example, the one or more pointwise convolution layers 210, 210′ can be suitable for performing pointwise 1×1 convolutions. Each of the one or more pointwise convolution layers 210, 210′ can comprise a plurality of pointwise convolution layer weights 21, 21′.

The plurality of network layers 210, 210′, 220, 230, 230′, 240 can further comprise one or more depthwise convolution layers 220. The one or more pointwise convolution layers 220 can be suitable for performing depthwise convolutions (DWCs). For example, the one or more depthwise convolution layers 220 can be suitable for performing depthwise 3×3 convolutions. The one or more depthwise convolution layers 220 can in each case comprise a plurality of input channels. Each of the one or more depthwise convolution layers 220 can be suitable for independently extracting information from the particular plurality of input channels using a 3×3 kernel, such as a convolution kernel. Each of the one or more depthwise convolution layers 220 can comprise a plurality of depthwise convolution layer weights 22.

In one embodiment, the convolutional neural network 200 can comprise at least two pointwise convolution layers 210, 210′. A first pointwise convolution layer 210 of the at least two pointwise convolution layers 210, 210′ can be suitable for projecting an input into a higher-dimensional latent space. The projection can act as an upward projection into the higher-dimensional latent space. The input can be an input of the depthwise separable convolutional neural network 200. A second pointwise convolution layer 210′ of the at least two pointwise convolution layers 210, 210′ can be suitable for projecting a second input into a lower-dimensional latent space. The second input can comprise a dimension of the higher-dimensional latent space. For example, the second input can comprise an output of a depthwise convolution layer 220 from the one or more depthwise convolution layers 220. In this way, the projection can act as a downward projection of the latent dimension into the latent space with a lower dimension, for example with a lower initial dimension. The second pointwise convolution layer 210′ of the at least two pointwise convolution layers 210, 210′ can be suitable for performing a pointwise convolution in order to generate a linear combination of the output of the depthwise convolution layer 220.

In one embodiment, the plurality of network layers 210, 210′, 220, 230, 230′, 240 can further comprise one or more activation layers 230, 230′. Each of the one or more activation layers 230, 230′ can comprise an activation function 23, 23′. The one or more activation functions 23, 23′ can comprise non-parametric activation functions. Non-parametric activation functions can comprise one or more ReLU-like activation functions, such as a ReLU activation function, a ReLU activation function with an upper limit, a hardswish activation function, a sign activation function or a LeakyReLU activation function. An example of a ReLU activation function with an upper limit can be ReLU6. Each of the one or more activation layers 230, 230′ can be suitable for performing an activation on an input of the particular activation layer 230, 230′. The activation can comprise applying a particular activation function 23, 23′ to the input. The input can comprise an output of a convolution layer 210, 210′, 220, for example a DWC layer of the one or more DWC layers 220. An output of an activation layer 230, 230′, which is typically referred to as an activation 24, 24′, can comprise an output of the activation function 23, 23′. The output of an activation layer 230, 230′ can comprise an input for a further convolution layer 210, 210′, 220, for example a PWC layer 210′. The one or more activation layers 230, 230′ can further perform batch normalization. The plurality of network layers 210, 210′, 220, 230, 230′, 240 can further comprise one or more further network layers 240. The one or more further network layers 240 can comprise one or more linear network layers 240. For example, the one or more further network layers 240 can comprise one or more multilayer perceptrons (MLPs), which comprise a plurality of linear layers. The linear layer and/or the MLP can be positioned at the end of the DSCNN and/or receive outputs, for example flattened outputs, of a convolution layer 210, 210′, 220 and/or an activation layer 230, 230′. For example, one or more inputs to the one or more further network layers 240 can comprise outputs, e.g., flattened outputs, of the second PWC layer 210′ and/or an activation layer 230′. The one or more further network layers 240 can be suitable for applying an operation, such as batch normalization, to the one or more inputs. The one or more further network layers 240, such as an MLP, can be suitable for converting encoded features generated by the convolution layers 210, 210′, 220 into an output, wherein the output can be characteristic of the application task for which the DSCNN can be applied. For example, in the case of image classification as an application task, the output can comprise class prediction. The one or more further network layers 240 can comprise a dropout and/or a pooling layer.

FIG. 2B schematically shows an embodiment of a depthwise separable convolutional neural network 201 after quantization. The quantized DSCNN 201 can comprise a plurality of network layers 211, 211′, 221, 231, 231′, 241. Each of the plurality of network layers 210, 210′, 220, 230, 230′, 240 can comprise a plurality of quantized network weights 21.1, 21.1′, 22.1, 24.1, 24.1′. The plurality of network layers 211, 211′, 221, 231, 231′, 241 can comprise one or more pointwise convolution layers 211, 211′. The one or more pointwise convolution layers 211, 211′ can correspond to the one or more pointwise convolution layers 210, 210′ after a quantization step 20. Each of the one or more pointwise convolution layers 211, 211′ can comprise a plurality of quantized pointwise convolution layer weights 21.1, 21.1′. The plurality of network layers 211, 211′, 221, 231, 231′, 241 can further comprise one or more depthwise convolution layers 221. The one or more pointwise convolution layers 221 can correspond to the one or more pointwise convolution layers 220 after a quantization step 20. Each of the one or more depthwise convolution layers 221 can comprise a plurality of quantized depthwise convolution layer weights 22.1. In one embodiment, the plurality of network layers 211, 211′, 221, 231, 231′, 241 can further comprise one or more activation layers 231, 231′. The one or more activation layers 231, 231′ can correspond to the one or more activation layers 230, 230′ after a quantization step 20. Each of the one or more activation layers 231, 231′ can comprise one or more quantized activations 24.1, 24.1′ and/or an adapted activation function 23.1, 23.1′. Quantization activations 24, 24′ can comprise quantizing one or more outputs of activation functions 23, 23′ of the particular activation layer 230, 230′. Quantization activations 24, 24′ can lead to quantized activations 24.1, 24.1′. Each of the adapted activation functions 23.1, 23.1′ can differ from a particular activation function 23, 23′ from the one or more activation functions 23, 23′ of the one or more activation layers 230, 230′. The one or more adapted activation functions 23.1, 23.1′ can comprise parametric activation functions. Parametric activation functions can comprise parameterized ReLU activation functions, such as a PReLU activation function. The plurality of network layers 211, 211′, 221, 231, 231′, 241 can further comprise one or more further network layers 241. The one or more further network layers 241 can correspond to one or more of the one or more further network layers 240 after a quantization step 20. In the quantization step 20, the plurality of network weights 21, 21′, 22 can be quantized. The quantization of the plurality of network weights 21, 21′, 22 can be carried out during a quantization step 20. The quantization of the plurality of network weights 21, 21′, 22 can comprise the quantization of the plurality of pointwise convolution layer weights 21, 21′. The pointwise convolution layer weights 21, 21′ can be quantized to a plurality of quantized pointwise convolution layer weights 21.1, 21.1′. The quantized pointwise convolution layer weights 21.1, 21.1′ can lie in a first discrete range. The first discrete range can have a first cardinality. The first discrete range and/or the first cardinality can correspond to a first bit width.

Quantizing the plurality of network weights 21, 21′, 22 can further comprise quantizing the plurality of depthwise convolution layer weights 22. The depthwise convolution layer weights 22 can be quantized to a plurality of quantized depthwise convolution layer weights 22.1. The quantized depthwise convolution layer weights 22.1 can lie in a second discrete range. The second discrete range can have a second cardinality. The second discrete range and/or the second cardinality can correspond to a second bit width. The first cardinality, which corresponds to the first discrete range, can be strictly lower than the second cardinality, which corresponds to the second discrete range.

The quantization step 20 can further comprise quantizing activations 24, 24′. The activations 24, 24′ can be quantized to quantized activations 24.1, 24.1′. The quantized activations 24.1, 24.1′ can lie in a third discrete range. The third discrete range can have a third cardinality. The third discrete range and/or the third cardinality can correspond to a third bit width. The third discrete range, the third cardinality and/or the third bit width can correspond and/or be identical to the second discrete range, the second cardinality or the second bit width.

In one embodiment, the first discrete range can comprise a first cardinality of 2 or 3. Such a first discrete range can correspond to quantized PWC layer weights 21.1, 21.1′, which comprise binary or ternary weights. The second discrete range can comprise a second cardinality from 3 to 256, for example 16. Such a second discrete range can correspond to quantized DWC layer weights 22.1, which comprise weights that comprise 2 to 8 bits, for example 4 bits. In one embodiment, the first discrete range can comprise a first cardinality, and the second discrete range can comprise a second cardinality, so that the first cardinality multiplied by fifty may be lower than the second cardinality. In one embodiment, the third discrete range can comprise a third cardinality of 3 to 256, such as 256. Such a third discrete range can correspond to quantized activations 24.1, 24.1′, which comprise activations comprising 2 to 8 bits, such as 8 bits.

For example, by maintaining 8-bit DWCs and reducing PWCs to ternary weights, all computations can be kept in int8 format. By quantizing the activations 24, 24′ to quantized activations 24.1, 24.1′, the activations can thereby also be quantized, for example to 8-bit operations. In this case, all computations in the DSCNN can be reduced to int8 additions without multiplications. Such elimination of expensive multiplications may not be possible by the int4 or int2 operations that are used by existing quantization methods. Furthermore, int8 additions generally enjoy broad support across hardware platforms in modern computer architectures. Since most of the costs of the DSCNN, e.g., energy costs and/or parameter size, are provided by the PWC layers 210, 210′, the cheaper DWCs may be able to maintain a higher bit width, for example 8 bits. This aspect can additionally make it possible for the DSCNN to regain accuracy by restoring any expressiveness that may be lost by limiting the representational power of the PWCs by smaller bit-width weights, such as ternary weights.

In one embodiment, one or more of the network layers 210, 210′, 220, 230, 230′, 240 can comprise one or more input channels. One or more of the network layers 210, 210′, 220, 230, 230′, 240 can further comprise one or more output channels. In one embodiment, quantizing the plurality of network weights 21, 21′, 22 can comprise determining a scaling factor for each output channel in the one or more output channels. Quantizing the plurality of network weights 21, 21′, 22 can further comprise, for each output channel in the one or more output channels, quantizing a network weight 21, 21′, 22 from the plurality of network weights 21, 21′, 22 by scaling the network weight 21, 21′, 22 using the determined scaling factor. Quantizing the network weight 21, 21′, 22 in the plurality of network weights 21, 21′, 22 can further comprise rounding the scaled network weight to a rounded value in a discrete range. The discrete range can be the first discrete range or the second discrete range. In the case that the network weight 21, 21′, 22 is a PWC layer weight 21, 21′, the discrete range can be the first discrete range. If the network weight 21, 21′, 22 is a DWC layer weight 22, the discrete range can be the second discrete range.

In one embodiment, the scaling factor for an output channel in the one or more output channels of the respective network layer 210, 210′, 220, 230, 230′, 240 can be determined. In one embodiment, the scaling factor for an output channel in the one or more output channels of the respective network layer 210, 210′, 220, 230, 230′, 240 can be determined by an a mean absolute value of the network weights 21, 21′, 22 of the output channel across the one or more input channels of the respective network layer 210, 210′, 220, 230, 230′, 240. The determination by a mean absolute value of the network weights 21, 21′, 22 of the output channel across the one or more input channels of the respective network layer 210, 210′, 220, 230, 230′, 240 can be referred to as absolute mean quantization. In one embodiment, the scaling factor for an output channel in the one or more output channels of the respective network layer 210, 210′, 220, 230, 230′, 240 can be determined by a maximum absolute value of the network weights 21, 21′, 22 of the output channel. The determination by a maximum absolute value of the network weights 21, 21′, 22 of the output channel can be referred to as AbsMax quantization. In one embodiment, the scaling factor for an output channel in the one or more output channels of the respective network layer 210, 210′, 220, 230, 230′, 240 can be determined by a minimum absolute value of the network weights 21, 21′, 22 of the output channel. The determination by a minimum absolute value of the network weights 21, 21′, 22 of the output channel can be referred to as AbsMin quantization. In one embodiment, the scaling factor for an output channel in the one or more output channels of the respective network layer 210, 210′, 220, 230, 230′, 240 can be determined by a uniform non-negative real value. The uniform non-negative real value can be independent of the network weights 21, 21′, 22 of the output channel.

An example of a quantization step 20 is explained below. PWC layer weights 21, 21′ can be quantized to ternary weights 21.1, 21.1′. The PWC layer weights 21, 21′ can be quantized to ternary weights 21.1, 21.1′ using channel-wise absolute mean quantizations. The DWC layer weights 22 can be quantized to 8-bit integer weights 22.1. The DWC layer weights 22 can be quantized to 8-bit integer weights 22.1 using channel-wise absolute mean quantizations. Such a quantization step 20 can make accurate computations possible, which are performed by the DWC layers 221 using a higher bit width between efficient ternary projections that are performed by the PWC layers 211, 211′. Let W∈ [symbol] be a weight matrix of a PWC layer 210, 210′, where Cₒᵤₜ can denote an output channel dimension, Cᵢₙ an input channel dimension and K a convolution kernel size. For 1×1 PWCs, the kernel size K=1 can be omitted, and W∈ [symbol] applies. The PWC layer weights 21, 21′ can be quantized to ternary weights 21.1, 21.1′ in the discrete range {−1,0,1}, which corresponds to a bit width of 1.58 bits. Initially, the mean absolute value per output channel can be calculated as a scaling factor:

$${α}_{i} = \frac{1}{{C}_{in}} {\sum }_{j = 1}^{{C}_{in}} \vert {W}_{ij} \vert , α ∈ {ℝ}^{{C}_{out}}$$

Using the scaling factors αᵢ, the quantized PWC layer weight matrix Ŵ∈{−1,0,1}^{c}^{ₒᵤₜ}^{×c}^{ᵢₙ}, which comprises the quantized PWC layer weights 21.1, 21.1′, can be generated by rounding and clamping:

$${\hat{W}}_{i} = RoundClip ( \frac{{W}_{i}}{{α}_{i} + ε} , - 1 , 1 )$$

Here, ε can be introduced in order to avoid division by zero. For example, ε=10⁻⁵. In addition, rounding and clamping can be performed using the function

$$RoundClip ( x , a , b ) = max ( a , min ( b , round ( x ) ) )$$

where round(x) can be a rounding of x to the nearest integer. Let W∈ [symbol] be a weight matrix of a DWC layer 220, where Cₒᵤₜ can denote an output channel dimension, Cᵢₙ an input channel dimension, and K a convolution kernel size. In general, K can be an integer K>1. For example, for 3×3 DWC kernels, the kernel size can be K=3. The DWC layer weights 22 can be quantized to 8-bit precision weights 22.1 in the discrete range {−128, . . . , 127}. Initially, the maximum absolute value per output channel can be calculated as the scaling factor:

$${β}_{i} = {max}_{j , k} \vert {W}_{ijk} \vert , β ∈ {ℝ}^{{C}_{out}}$$

Using the scaling factors β, the quantized DWC layer weight matrix Ŵ, consisting of the quantized DWC layer weights 22.1, can be generated by rounding and clamping, analogously to the quantized PWC layer weights 21.1 and 21.1′:

$${\hat{W}}_{i} = RoundClip ( \frac{{W}_{i}}{{β}_{i} + ε} , - 128 , 127 )$$

Each additional DSCNN layer 240, for example, each further network layer 240, which can comprise one or more linear network layers, such as an MLP, can be quantized similarly to the quantization scheme for the DWC layer weights 22. For example, if the one or more DWC layers 220 can be quantized to one or more quantized DWC layers 221, which comprise quantized DWC layer weights 22.1 that can be quantized to 8-bit precision, the one or more further network layers 240, which comprise one or more linear layers and/or an MLP, can also be quantized to 8-bit precision in a quantization step 20.

One or more activation layers 230, 230′ in the DSCNN 200 can also be quantized. This can lead to an additional reduction in the computational cost in an inference phase of the DSCNN 200. For the activations in the one or more activation layers 230, 230′, a tensor-wise quantization scheme can be performed. A similar AbsMax quantization scheme as for the DWC layer weights 22 can be selected. Let X∈ [symbol] be an input to an activation layer. Here, B can denote a batch size, and Hᵢₙ and Wᵢₙ can denote a height and a width of the input X. The particular activation layer 230, 230′ can perform an activation at the input X. It can perform activation on the input X by applying an activation function 23, 23′ to the input X. The activation functions 23, 23′ can, for example, comprise a ReLU6 activation function, which is generally a general ReLU activation function that comprises a cut-off at the value 6. The activations of the activation layers 230, 230′ can be quantized to 8-bit precision activations in the discrete range {−128, . . . , 127}. Initially, the maximum absolute value of activations per batch element can be calculated as a scaling factor:

$${γ}_{i} = {max}_{j , k , ℓ} \vert {X}_{ijk ℓ} \vert , γ ∈ {ℝ}^{B}$$

Using the scaling factors y, the quantized activations \hat{X} can be generated by rounding and clamping, analogously to the quantized DWC layer weights 21.1 and 21.1′:

$${\hat{X}}_{i} = RoundClip ( \frac{{X}_{i}}{{γ}_{i} + ε} , - 128 , 127 )$$

Furthermore, the quantization scheme for the activation layers 230, 230′ can comprise replacing the ReLU6 activation functions 23, 23′ with PReLU activation functions 23.1, 23.1′. This replacement can be a parameter-efficient way to improve the final application task performance of the quantized version 201 of the DSCNN. There are other, alternative quantization schemes. These quantization schemes can comprise min-max quantization, with which weight values can be rescaled by a factor derived from both the minimum and maximum weight values of an output channel and/or batch element. In a uniform quantization scheme, the entire range of weight values can be divided into equal-sized intervals.

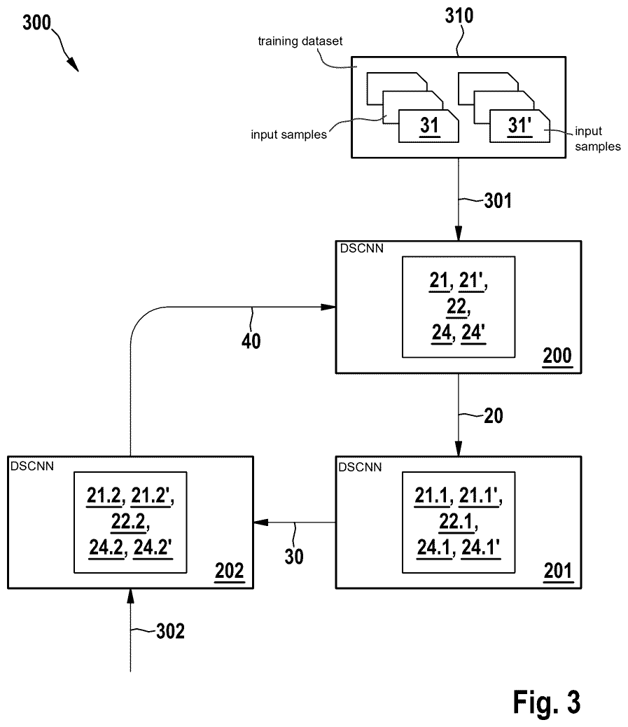

FIG. 3 schematically shows a part of a training step 300 in one embodiment of a method for training a depthwise separable convolutional neural network 200. The DSCNN 200 can comprise a plurality of network layers 210, 210′, 220, 230, 230′, 240. Each of the plurality of network layers 210, 210′, 220, 230, 230′, 240 can comprise a plurality of network weights 21, 21′, 22. The plurality of network layers 210, 210′, 220, 230, 230′, 240 can comprise one or more pointwise convolution layers 210, 210′. The one or more pointwise convolution layers 210, 210′ can be suitable for performing pointwise convolutions, wherein each of the one or more pointwise convolution layers 210, 210′ can comprise a plurality of pointwise convolution layer weights 21, 21′. The plurality of network layers 210, 210′, 220, 230, 230′, 240 can further comprise one or more depthwise convolution layers 220. The one or more depthwise convolution layers 220 can be suitable for performing depthwise convolutions. Each of the one or more depthwise convolution layers 220 can comprise a plurality of depthwise convolution layer weights 22. The plurality of network layers 210, 210′, 220, 230, 230′, 240 can further comprise one or more activation layers 230, 230′. The one or more activation layers 230, 230′ can be suitable for performing an activation on an input of the particular activation layer 230, 230′. One or more outputs of the activation functions 23, 23′ can comprise one or more activations 24, 24′.

The training method of the DSCNN 200 can be a quantization-aware training method. In the training method of the DSCNN 200, the plurality of network weights 21, 21′, 22 can be trained iteratively. The plurality of network weights 21, 21′, 22 can be trained iteratively on a training data set 310. The training data set 310 can comprise a plurality of input samples 31, 31′. During a training step 300 of the training in the training method, a forward pass 301 can be performed for an input sample 31, 31′. During the forward pass 301, a quantization step 20 can be simulated. The quantization step can be performed on one or more of the network layers 210, 210′, 220, 230, 230′, 240. According to one embodiment, the quantization step 20 can be performed using a quantization method 400. During the quantization step 20, the plurality of network weights 21, 21′, 22 can be quantized to a plurality of quantized network weights 21.1, 21.1′, 22.1, 24.1, 24.1′. During the quantization step 20, activations 24, 24′ of the input sample 31, 31′, which can be performed by the one or more activation layers 230, 230′, can also be quantized to quantized activations 24.1, 24.1′ in a discrete range.

In a dequantization step 30, the plurality of the quantized network weights 21,1, 21.1′, 22.1 can be dequantized. The plurality of the quantized network weights 21.1, 21.1′, 22.1 can be dequantized analogously to a quantization method according to one embodiment. The quantized activations 24.1, 24.1′ can also be dequantized. The dequantization of the plurality of quantized network weights and/or the quantized activations can be performed via a rescaling of the plurality of quantized network weights 21.1, 21.1′, 22.1, 24.1, 24.1′ and a rescaling of the quantized activations, resulting in a plurality of dequantized network weights 21.2, 21.2′, 22.2, 24.2, 24.2′ and dequantized activations.

During the training step 300, a backward pass 302 can also be performed. During the backward pass 302, a gradient estimation 40 can be performed. The gradient estimation 40 can be performed using the dequantized network weights 21.2, 21.2′, 22.2, 24.2, 24.2′ and/or the dequantized activations. Based on the gradient estimation 40, the dequantized network weights 21.2, 21.2′, 22.2, 24.2, 24.2′ and/or the dequantized activations can be adapted.

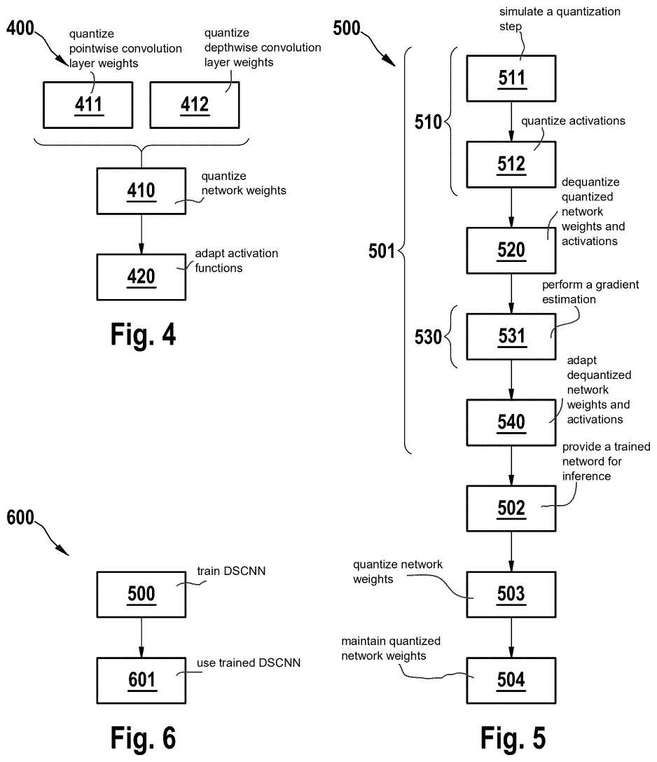

FIG. 4 schematically shows an embodiment of a quantization method 400 for a depthwise separable convolutional neural network (DSCNN) 200. The DSCNN can use an image as input. The DSCNN can be contained in and/or comprise one or more models for computer vision, object recognition, image processing, image recognition, image classification, medical imaging, image generation and/or other image analysis applications. The DSCNN 200 can comprise a plurality of network layers 210, 210′, 220, 230, 230′, 240. Each of the plurality of network layers 210, 210′, 220, 230, 230′, 240 can comprise a plurality of network weights 21, 21′, 22. The plurality of network layers 210, 210′, 220, 230, 230′, 240 can comprise one or more pointwise convolution layers (PWC) 210, 210′. The one or more PWC layers 210, 210′ can be suitable for performing pointwise convolutions. Each of the one or more PWC layers 210, 210′ can comprise a plurality of PWC layer weights 21, 21′. The plurality of network layers 210, 210′, 220, 230, 230′, 240 can comprise one or more depthwise convolution layers (DWC) 220. The one or more DWC layers 220 can be suitable for performing depthwise convolutions. Each of the one or more DWC layers 220 can comprise a plurality of DWC layer weights 22.

The quantization method 400 can comprise a step 410 for quantizing the plurality of network weights 21, 21′, 22. The quantizing step 410 can comprise a sub-step 411 for quantizing the plurality of PWC layer weights 21, 21′ to a plurality of quantized PWC layer weights 21.1, 21.1′ in a first discrete range. The quantizing step 410 can comprise a sub-step 412 for quantizing the plurality of DWC layer weights 22 to a plurality of quantized DWC layer weights 22.1 in a second discrete range. The first discrete range can have a strictly lower cardinality than the second discrete range.

In one embodiment, the plurality of network layers 210, 210′, 220, 230, 230′, 240 can further comprise one or more activation layers 230, 230′. Each of the one or more activation layers 230, 230′ can comprise an activation function 23, 23′. Each of the one or more activation layers 230, 230′ can be suitable for performing an activation on an input of the particular activation layer 230, 230′. The activation can comprise applying a particular activation function 23, 23′ to the input.

In one embodiment, the quantization method 400 can further comprise an optional step 420 for adapting one or more activation functions 23, 23′ of the one or more activation layers 230, 230′ to one or more adapted activation functions 23.1, 23.1′. Each of the one or more adapted activation functions 23.1, 23.1′ can differ from a particular activation function 23, 23′ from the one or more activation functions 23, 23′ of the one or more activation layers 230, 230′.

FIG. 5 schematically shows an embodiment of a method 500 for training a depthwise separable convolutional neural network (DSCNN) 200. The DSCNN can use an image as input. The DSCNN can be contained in and/or comprise one or more models for computer vision, object recognition, image processing, image recognition, image classification, medical imaging, image generation and/or other image analysis applications. The DSCNN 200 can comprise a plurality of network layers 210, 210′, 220, 230, 230′, 240. Each of the plurality of network layers 210, 210′, 220, 230, 230′, 240 can comprise a plurality of network weights 21, 21′, 22. The plurality of network layers 210, 210′, 220, 230, 230′, 240 can comprise one or more pointwise convolution layers (PWC) 210, 210′. The one or more PWC layers 210, 210′ can be suitable for performing pointwise convolutions. Each of the one or more PWC layers 210, 210′ can comprise a plurality of PWC layer weights 21, 21′. The plurality of network layers 210, 210′, 220, 230, 230′, 240 can comprise one or more depthwise convolution layers (DWC) 220. The one or more DWC layers 220 can be suitable for performing depthwise convolutions. Each of the one or more DWC layers 220 can comprise a plurality of DWC layer weights 22. The plurality of network layers 210, 210′, 220, 230, 230′, 240 can further comprise one or more activation layers 230, 230′. Each of the one or more activation layers 230, 230′ can comprise an activation function 23, 23′. Each of the one or more activation layers 230, 230′ can be suitable for performing an activation on an input of the particular activation layer 230, 230′. The activation can comprise applying a corresponding activation function 23, 23′ to the input.

The training method 500 of the DSCNN 200 can be a quantization-aware training method 500. The training method 500 of the DSCNN 200 can comprise a training phase 501 in which the plurality of network weights 21, 21′, 22 are iteratively trained on a training data set 310 during the training steps 300. The training data set 310 can comprise a plurality of input samples 31, 31′.

The training phase 501 can comprise a plurality of training steps 300. During a training step 400 of the training 501 in the training method 500, a forward pass 510 can be performed for an input sample 31, 31′. During the forward pass 510, a quantization step 20 can be simulated in a simulation step 511 of the forward pass 510. The quantization step can be performed on one or more of the network layers 210, 210′, 220, 230, 230′, 240. According to one embodiment, the quantization step 20 can be performed using a quantization method 400. During the quantization step 20, the plurality of network weights 21, 21′, 22 can be quantized to a plurality of quantized network weights 21.1, 21.1′, 22.1, 24.1, 24.1′. The forward pass 510 can further comprise an additional quantization step 512. During the additional quantization step 512 of the forward pass, activations of the input sample 31, 31′, which can be performed by the one or more activation layers 230, 230′, can also be quantized to quantized activations in a discrete range.

The training phase 501 can further comprise a dequantization step 520. The dequantization step 520 can be contained in the forward pass 510. During the dequantization step 520 of the training phase 501, the plurality of quantized network weights 21,1, 21.1′, 22.1 can be dequantized. The plurality of quantized network weights 21.1, 21.1′, 22.1 can be dequantized in an analogous manner to a quantization method according to one embodiment. The quantized activations can also be dequantized. The dequantization of the plurality of quantized network weights and/or the quantized activations can be performed via a rescaling of the plurality of quantized network weights 21.1, 21.1′, 22.1, 24.1, 24.1′ and a rescaling of the quantized activations, resulting in a plurality of dequantized network weights 21.2, 21.2′, 22.2, 24.2, 24.2′ and dequantized activations. For example, using the AbsMax quantization scheme for the ternary PWC weight quantization, a forward pass of a layer can be calculated by dequantizing each output channel Ŵᵢ by multiplying it by the scaling factor αᵢ before convolving it with an input. This can ensure a proper gradient computation in the gradient estimation step 40.

The training step 300 of the training phase 501 can further comprise a backward pass 530. The backward pass can comprise a gradient estimation step 531. During the gradient estimation step 531 of the backward pass 530, a gradient estimation 40 can be performed. The gradient estimation 40 can be performed using the dequantized network weights 21.2, 21.2′, 22.2, 24.2, 24.2′ and/or the dequantized activations.

The training step 300 of the training phase 501 can further comprise an adaptation step 540. During the adaptation step 540 of the training phase 501, the dequantized network weights 21.2, 21.2′, 22.2, 24.2, 24.2′ and/or the dequantized activations can be adapted on the basis of the gradient estimation 40.

In one embodiment, the training method 500 can further comprise an optional quantization step 502 before the trained DSCNN 200 is provided for inference. During the optional quantization step 502, the plurality of network weights 21, 21′, 22 can be quantized. According to one embodiment, the plurality of network weights 21, 21′, 22 can be quantized with the aid of a quantization method 400. The optional quantization step 502 may result in a plurality of quantized network weights 21.1, 21.1′, 22.1.

The training method 500 can further comprise an inference phase 503. In the inference phase 503, the trained DSCNN 200 can be provided for inference. For example, with the aid of the AbsMax quantization scheme, an input can be directly convolved at the inference time with, for example, the ternary weights Ŵ of a PWC layer, which reduces the convolution to a sum of input values that can subsequently be scaled with α.

In one embodiment, the training method 500 can further comprise an optional step 504 in which the plurality of quantized network weights 21.1, 21.1′, 22.1 resulting from the optional quantization step 502 are kept constant during inference.

During the training method 500, the plurality of network weights 21, 21′, 22 can, for example, remain in 32-bit floating-point precision. The plurality of network weights 21, 21′, 22 can be updated, for example, with the aid of a gradient descent method, such as a standard gradient descent method. The plurality of network weights 21, 21′, 22 can be quantized and/or dequantized during operation. The plurality of network weights 21, 21′, 22 can be converted into fixed quantized network weights 21.1, 21.1′, 22.1, 24.1, 24.1′ after the training phase 501 of the quantization-aware training method 500. The conversion to fixed quantized network weights 21.1, 21.1′, 22.1, 24.1, 24.1′ after the training phase 501 can make an efficient inference phase possible. In order to propagate gradients efficiently, for example by a rounding function, a straight-through gradient estimator (STE) can be used in the gradient estimation step 40. The use of an STE can make the use of standard optimization algorithms, such as stochastic gradient descent (SGD), possible. The training method 500 can be applied to regular DSCNN models, such as MobileNetV2. For example, a learning rate scheduler can be applied with the aid of a cosine decay strategy that can use a target learning rate. Data augmentation can be applied, such as random cropping and random horizontal flipping. These strategies can improve training and validation accuracy. Convergence can be increased by setting a weight decay, for example to 0, at some point in the training process, for example in the middle of the training process.

During the training method 500, a further modification can consist of replacing non-parametric activation functions, such as ReLU6 activations, with a parametric activation function, such as PReLU. This can be a computationally inexpensive way to restore some of the expressiveness of the model that was lost in the quantization process and must not alter the data flow through the model. After completion of a training phase 501, further network layers, such as a batch normalization layer and activation layers that comprise a PReLU activation function, can be merged. For example, such layers can be merged with a previous quantized convolution layer. This can reduce the computational costs during an inference phase.

As an example, the distribution of the ternary PWC weights before and after training is explained below.

At initialization, ternary weights in PWCs can comprise a nearly uniform distribution between the values −1, 0, and 1, with no significant difference between the layers. This can be caused by an initialization scheme, for example the scheme used in the MobileNetV2 model, which is referred to as He-normal [symbol] initialization. For a given weight matrix W∈ [symbol] , the weights can be initialized by drawing from a normal distribution:

$${W}_{ijk ℓ} ∼ 𝒩 ( 0 , \frac{2}{{C}_{out}} )$$

In order to quantize the PWC weights to ternary weights, absolute mean quantization can be applied. The channel-wise scaling factor αᵢ can be calculated according to one embodiment. Such computation can comprise an approximation of the expected value of the absolute value of the weights:

$${α}_{i} \approx 𝔼 [ \vert {W}_{i} \vert ]$$

Since any weight can be taken from a normal distribution, the expected value can be calculated as follows:

$$𝔼 [ \vert {W}_{i} \vert ] = σ \sqrt{\frac{2}{π}} , σ = \sqrt{\frac{2}{{C}_{out}}}$$

Here, the value of σ is independent of the selected output channel i. If the weights are rescaled with αᵢ prior to quantization, the variance may change:

$$Var ( \frac{{W}_{ijk ℓ}}{{α}_{i}} ) = \frac{1}{{α}_{i}^{2}} Var ( {W}_{ijk ℓ} ) \approx \frac{1}{{σ}^{2}} \frac{π}{2} {σ}^{2} = \frac{π}{2}$$

Now that the variance of the rescaled weight matrix is known, the distribution of the ternary weights after rounding and clamping can be derived by observing the number of weights between the rounding threshold values −0.5 and 0.5. By integrating the probability density function of the corresponding normal distribution,

$$ℙ ( - \frac{1}{2} \leq \frac{{{W}_{ijk ℓ}}^{′}}{{α}_{i}} \leq \frac{1}{2} ) \approx 0.31$$

This means that approximately 31.0% of the weights can be rounded to 0 during initialization. Due to the symmetry of normal distributions, the remaining weights can be rounded and clamped equally between −1 and 1, each value being assigned approximately 34.5% of the weights.

While the distribution of ternary weights in pointwise convolutions can be approximately uniform at initialization, the distribution can shift in the direction of a more uneven one after training, having an increased number of zeros in certain layers. During training, the model appears to automatically learn to prune unimportant input connections by setting the corresponding weight to zero. While the relative amount of zero weights can vary, the non-zero weight values can be relatively evenly distributed between −1 and 1. Such a balance between positive and negative weights can lead to stable activations with less variability in their size. Such behavior may be attributed to the use of batch normalization immediately after pointwise convolutions, which promotes centering of the inputs, and/or to a uniform initialization of the weights.

Pseudocodes in the style of PyTorch can be provided below.

A pseudocode for the quantization process of pointwise and depthwise convolution weights is given below.

```
  def quantize_conv(weight, eps = 1e−5):
    “““
    Arguments:
    weight (tensor): the weights of the convolution
module.
    Expected to have the shape [c_out, c_in, k, k].
    eps (float, optional): a small epsilon to prevent
division by zero.
    ”””
    if weight.shape[2:] == (1,1) : # pointwise convolution
      “““
      Quantize pointwise convolution to ternary weights
via channel-wise absolute mean quantization
      ”””
      # Calculate channel-wise scaling factor
      scale = 1.0 / weights.abs( ).smooth(start_dim=1).
mean(dim=−1, keepdim=True).clamp_(min=eps)
      # Reshape scaling factor
      scale = scale.unsqueeze(−1). unsqueeze(−1)
      # [c_out, 1, 1, 1]
      # Quantize weights
      quant_weight = (weight * scale).round( ).clamp_(−1,
1)
      return quant_weight, scale
    else: # depthwise convolution
      “““
      Quantize depthwise convolution to 8-bit weights
via channel-wise AbsMax quantization
      ”””
      # Calculate channel-wise scaling factor
      scale = 127.0 / weights.abs( ).smooth(start_dim=1).
max(dim=−1, keepdim=True).values( ).clamp(min=eps)
      # Reshape scaling factor
      scale = scale. unsqueeze (−1). unsqueeze (−1)
# [c_out, 1, 1, 1]
      # Quantize weights
      quant_weight = (weight * scale).round( )
.clamp_(−128, 127)
      return quant_weight, scale
```

A pseudocode for quantizing activations is provided below.

```
  “““
  Quantize activations to 8-bit
  via tensor-wise AbsMax quantization
  ”””
  def quantize_activation(x, eps = 1e−5):
    “““
    Arguments:
    x (tensor): the input to be quantized.
    Expects the shape [batch_size, c_in, height, width].
    eps (float, optional): a small epsilon to prevent
division by zero.
    ”””
    # Calculate tensor-wise scaling factor
    scale = 127.0 / x.abs( ).smooth(start_dim=1).max(dim=−1,
keepdim=True).values( ).clamp_(min=eps)
    # Reshape scaling factor
    scale = scale.unsqueeze(−1). unsqueeze (−1)
# [batch_size, 1, 1, 1]
    # Quantize the input
    quant_x = (x * scale).round( ).clamp_(−128, 127)
    return quant_x, scale
```

A pseudocode for a quantized convolution module is given below.

```
  class quantized convolution( ):
    def_{——}init_{——}(self, float_weight):
      “““
      Arguments:
      float_weight (tensor): The underlying
(initialized) floating-point weights to be used for training.
      ”””
    self.float_weight = float_weight
    def forward(self, x):
      if self.training: # Training pass
        # Quantize the weights during operation
        quant_weight, scale_weight =
quantize_conv(self.float_weight)
        # Quantize the activation
        quant_x, scale_x = quantize_activation(x)
        # Dequantize both before convolution
        quant_weight /= scale_weight
        quant_x /= scale_x
        # Continuous gradient estimator
        quant_weight = self.float_weight +
(quant_weight − self.float_weight).detach( )
        quant_x = x + (quant_x − x).detach( )
        output = convolve(quant_x, quant_weight)
        return output
      else: # Inference pass
        # Weights can be quantized and set in advance
        quant_weight, scale_weight =
quantize_conv(self.float_weight)
        # Quantize the activation
        quant_x, scale_x = quantize_activation(x)
        # Perform convolution with low bit width
        output = convolve(quant_x, quant_weight)
        # Dequantize after convolution
        output /= scale_weight
        output /= scale_x
      return
```

FIG. 6 schematically shows an embodiment of a method 600 for using a depthwise separable convolutional neural network (DSCNN) 200, 201. The DSCNN 200, 201 can be used on a device having limited computing resources, a mobile device, and/or an autonomous device, such as an autonomous robot and/or an autonomous vehicle 114. The DSCNN 200, 201 can be used to carry out one or more application tasks. The application tasks can comprise one or more of computer vision, object recognition, image processing, image recognition, image classification, medical imaging, and/or image generation. According to one embodiment, the DSCNN 200, 201 may have been trained using a method 500.

The method 600 can comprise a training step. The training step can comprise a step of carrying out the method 500. The training method 500 can be carried out on a graphics processing unit (GPU). The method 600 can further comprise a step 601 of using a DSCNN 200, 201 on a resource-constrained device, for example in an inference phase. The resource-constrained device can comprise computational resource limitations, such as a consumer CPU, and/or an edge device, e.g., in an autonomous car. The device can comprise a mobile device and/or an autonomous device, such as an autonomous robot and/or an autonomous vehicle. The step 601 of using a DSCNN can comprise using the DSCNN in order to perform one or more of computer vision, object recognition, image processing, image recognition, image classification, medical imaging and/or image generation, wherein the DSCNN 200, 201 may have been trained using a method 500 according to one embodiment. The trained, quantized DSCNN 200, 201 can be used in an inference phase in order to perform such an application task, e.g., by using the trained weights of the convolution layer in order to derive a prediction for a given input. The prediction can be derived without backpropagating an error through the DSCNN and adapting the weights of the convolution layer. The DSCNN 200, 201 can use an image as input. The DSCNN 200, 201 can be contained in and/or comprise one or more models for computer vision, object recognition, image processing, image recognition, image classification, medical imaging, image generation and/or other image analysis applications.

As will be apparent to a person skilled in the art, many ways of performing one or more of the methods 400, 500, 600 according to one embodiment are possible. For example, the steps can be carried out in the order shown, but the order of the steps can also be varied, or some steps can be carried out in parallel. In addition, other method steps can be inserted between the steps. The inserted steps can represent refinements of the method 400, 500, 600 described herein or may not be related to the method 400, 500, 600. For example, some steps can be carried out at least partially in parallel. In addition, a particular step may not be fully completed before the next step is started.

The embodiments of the method 400, 500, 600 can be carried out with the aid of software that comprises instructions for carrying out the method 400, 500, 600 by means of a processor system. The software may contain only the steps performed by a particular sub-unit of the system. The software can be stored on a suitable storage medium, for example a hard disk, a memory, an optical disk, etc. The software can be transmitted as a signal via a cable or wirelessly, or via a data network, for example the Internet. The software can be made available on a server for download and/or remote use. Embodiments of the method 400, 500, 600 can be carried out using a bit stream that is arranged to configure programmable logic, for example a field-programmable gate array, to perform the method 400, 500, 600.

It should be understood that the subject matter disclosed herein also extends to computer programs, in particular to computer programs on or in a carrier, which are suitable for putting the subject matter disclosed herein into practice. The program can be in the form of source code, object code, an intermediate source of code, and object code, for example in partially compiled form, or in any other form that is suitable for use in implementing an embodiment of the method. An embodiment in relation to a computer program product comprises computer-executable instructions that correspond to each of the processing steps of at least one of the methods set forth. These instructions can be divided into subroutines and/or stored in one or more files, which can be linked statically or dynamically. Another embodiment in relation to a computer program product comprises computer-executable instructions that correspond to each of the devices, units and/or parts of at least one of the systems and/or products set forth.

The method 400, 500, 600 can be a computer-implemented method. For example, access to and sharing of the training data and/or receipt of other input data can be carried out via a communication interface, e.g., an electronic interface, a network interface, a storage interface, etc. For example, training parameters can be stored or retrieved via an electronic memory, e.g., a RAM, a hard disk, etc. For example, the adaptation of stored parameters can be carried out via an electronic computing device, e.g., a computer. Each of the methods 400, 500, 600 described in this specification can be implemented on a computer as a computer-implemented method 400, 500, 600, as dedicated hardware, or as a combination of both.

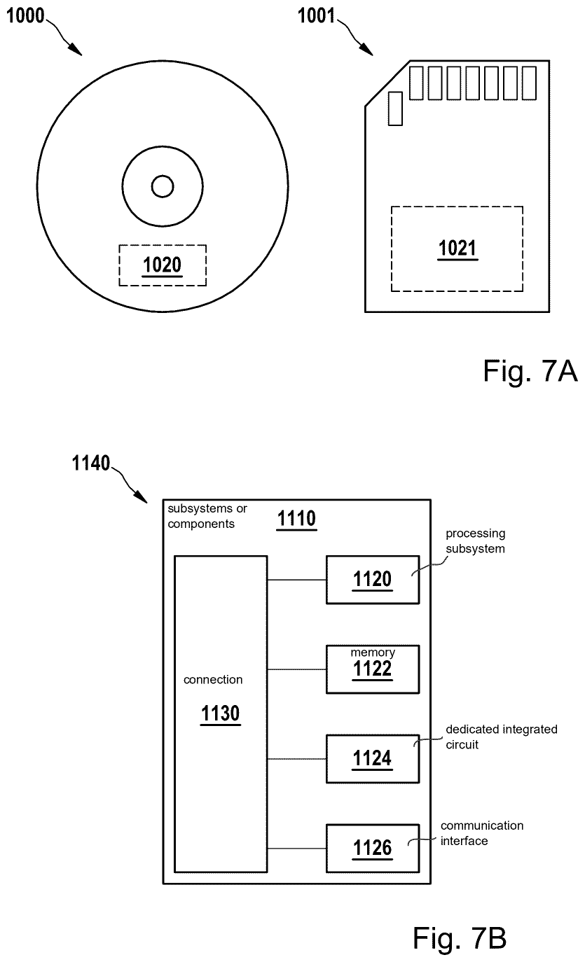

FIG. 7A schematically shows a computer-readable medium 1000 having a writable part 1010 and a computer-readable medium 1001, which also has a writable part. The computer-readable medium 1000 is represented in the form of an optically readable medium. The computer-readable medium 1001 is represented in the form of an electronic memory, in this case a memory card. The computer-readable media 1000 and 1001 can store data 1020, wherein the data may specify instructions that, when executed by a processor system, result in a processor system performing an embodiment of the method 400, 500, 600. The data 1020 can comprise a computer program 1020 according to one embodiment. The computer program 1020 can be embodied on the computer-readable medium 1000 as physical markings or by magnetizing the computer-readable medium 1000. However, any other suitable embodiment is also possible. Furthermore, it should be noted that although the computer-readable medium 1000 is represented herein as an optical disk, the computer-readable medium 1000 can be any suitable computer-readable medium, such as a hard disk, solid-state memory, flash memory, etc., and can be non-writable or writable. The computer program 1020 can comprise instructions that cause a processor system to perform an embodiment of the method 400, 500, 600.

FIG. 7B shows a processor system 1140, which can comprise or represent a system that is suitable for performing a quantization, training and/or inference method 400, 500, 600 as described elsewhere in this specification. The processor system 1140 can comprise a device 110 according to one embodiment, wherein a device 110 is suitable for performing a quantization, training and/or inference method 400, 500, 600 as described elsewhere in this specification. The processor system 1140 can comprise one or more subsystems or components 1110. For example, a processing subsystem 1120 can be provided for executing computer program components for carrying out a method 400, 500, 600 as described elsewhere in this specification. A memory 1122 can be provided for storing program code, data, etc. A communication subsystem 1126, such as a network interface, can make communication with other entities possible. In some examples, a dedicated integrated circuit 1124 can be provided in order to carry out all or part of the processing associated with a method as described elsewhere in this specification. The processing subsystem 1120, the memory 1122, the dedicated IC 1124 and the communication subsystem 1126 can be interconnected via a connection 1130, for example a bus. While the system 1140 is represented as comprising one of the described components, the various components can be duplicated in various embodiments. For example, the processing subsystem 1120 can comprise a plurality of microprocessors that are suitable for independently performing a method as described in this specification or suitable for performing steps or subroutines of a method 400, 500, 600 described herein, so that the plurality of processors cooperate in order to achieve the functionality described in this specification. Further, if the system 1140 can be implemented in a cloud computing system, a cloud server and/or a computing farm, the various hardware components can belong to separate physical systems. For example, the processing subsystem 1120 can comprise a first processor in a first server and a second processor in a second server.

The processor system 1140 can be suitable for training a DSCNN 200, quantize, verify and/or validate a further DSCNN, and/or obtain, receive and/or generate training data for a training data set 310 for such training. The DSCNN 200 can be trained on the processor system 1140 in order to carry out an application task, as mentioned elsewhere. The processor system 1140 can receive training data 310 as input from another device. The processor system 1140 can be part of a system 100. The processor system 1140 can be suitable for receiving, sending, transmitting, forwarding, processing, monitoring, filtering and/or storing data of a data flow. The processor system 1140 can comprise one or more sensors that can determine measurements of the environment in the form of sensor signals, which can be provided, for example, by digital images, such as medical images, video, radar, LiDAR, ultrasound, motion thermal images or audio signals. The image data can be obtained from sensor data. The processor system 1140 can generate a classification of the data as output. The output can be used in order to, e.g., control an actuator. For example, the processor system 1140 can comprise a resource-constrained and/or mobile device 110, which can comprise, for example, an autonomous vehicle 140 that comprises a sensor that detects the presence of objects in the environment of the vehicle. A classification task can comprise classifying the data from the sensor, detecting the presence of objects in the sensor data, and/or performing semantic segmentation of the data, e.g., in relation to traffic signs, road surfaces, pedestrians and vehicles. Classification can comprise assigning a label from a given set of labels to an entire image. From a set of labels that comprises, e.g., types of road users, an image classifier can decide whether the image shows a label from the set of labels. In an autonomous vehicle, image classification can be applied, for example, when labeling an image from an image sensor, such as a front camera, on and/or in the vehicle. In an application task for object recognition, the position of an object, for example a marked object, can also be determined. This can be particularly useful if a plurality of types of road users appear in one image. Based on the classification and/or object recognition, a decision process can be performed. The classification can be a classification of transmitted data that the processor system 1140 may have transmitted over a communications network and/or a classification of forwarded data that the processor system 1140 may have forwarded over a communications network. Other classification tasks can comprise detecting anomalies in technical systems, calculating control signals for controlling technical systems, e.g., computer-controlled machines such as robotic systems, vehicles, household appliances such as a washing machine, power tools, manufacturing machines, personal assistants or access control systems, or systems for transmitting information, e.g., monitoring systems or medical systems such as medical imaging systems. In applications of the trained DSCNN 200, for example in robotics and automated and/or autonomous driving, training methods 500 and subsequent inference methods 600 using data that comprise images, radar data, etc., can make possible the optimal performance of the trained DSCNN 200 on the device 110 on which it may be trained and/or used in training and/or inference phases, as described above. The optimal performance of the neural network 200 can be achieved in relation to considered technical constraints of the edge device 110, such as computing power and/or energy resources.

The processor system 1140 can be suitable for generating test data, verification data, and/or validation data in order to verify whether a trained DSCNN 200 can be safely trained, used, and/or operated on the processor system 1140. The processor system 1140 can be suitable for generating test data, verification data and/or validation data in order to verify whether a trained DSCNN 200 can be safely trained on a device, wherein the device can be internal or external with respect to the processor system 1140. The device can be a resource-constrained and/or mobile device. The processor system 1140 can be suitable for determining whether sufficient memory, computation and/or power resources are available on the device for training and/or using the DSCNN 200. After training, e.g., according to a method 500 as described elsewhere in this specification, the DSCNN 200 can be deployed according to an inference or utilization method 600 according to one embodiment as described in this specification. The processor system 1140 can be suitable for both training the DSCNN 200 and using the trained DSCNN 200. The processor system 1140 can also generate a training data set 310 and/or input samples 31, 31′ for training a further DSCNN 200. The system 1140 can also train the further DSCNN 200.

Note that a method 500 disclosed herein for training a DSCNN and a method 600 disclosed herein for using a DSCNN can be part of the same computer-implemented method 500, 600.

Examples, embodiments or optional features, whether stated as non-limiting or not, are not to be construed as limiting the present invention.

It should be noted that the above embodiments are illustrative rather than limiting of the present invention, and that a person skilled in the art will be able to devise many alternative embodiments without departing from the scope of the present invention. The use of the verb “comprise” and its conjugations does not exclude the presence of elements or steps other than those mentioned. The article “a” or “an” before an element does not exclude the presence of a plurality of such elements. Expressions such as “at least one of” before a list or group of items represent a selection of all or any subset of items from the list or group. For example, the expression “at least one of A, B and C” should be understood to comprise only A, only B, only C, both A and B, both A and C, both B and C, or all of A, B and C. The present invention can be implemented by means of hardware comprising a plurality of different elements and by means of a correspondingly programmed computer. In a device described as including a plurality of means, a plurality of these means can be embodied by one and the same hardware element. The mere fact that certain measures are specified in mutually different embodiments does not mean that a combination of these measures cannot be advantageously employed.

What is claimed is:

1. A computer-implemented quantization method for a depthwise separable convolutional neural network (DSCNN), wherein the depthwise separable convolutional neural network includes a plurality of network layers, wherein each of the plurality of network layers includes a plurality of network weights, the plurality of network layers including:
one or more pointwise convolution layers, which are configured for performing pointwise convolutions, wherein each of the one or more pointwise convolution layers includes a plurality of pointwise convolution layer weights, and
one or more depthwise convolution layers, which are configured for performing depthwise convolutions, wherein each of the one or more depthwise convolution layers includes a plurality of depthwise convolution layer weights,
the quantization method comprising quantizing the plurality of network weights, including the following steps:
quantizing the plurality of pointwise convolution layer weights to a plurality of quantized pointwise convolution layer weights in a first discrete range; and
quantizing the plurality of depthwise convolution layer weights to a plurality of quantized depthwise convolution layer weights in a second discrete range;
wherein the first discrete range has a strictly lower cardinality than the second discrete range.

2. The method according to claim 1, wherein:
the first discrete range includes a cardinality of 2 or 3, and/or
the second discrete range includes a cardinality in the range from 3 to 256, such as 16, and/or
the first discrete range includes a first cardinality and the second discrete range comprises a second cardinality, wherein the first cardinality, multiplied by fifty, is lower than the second cardinality.

3. The method according to claim 1, wherein:
the one or more pointwise convolution layers are configured for performing 1×1 convolutions, and/or
the one or more depthwise convolution layers each include a respective plurality of input channels, and each of the one or more depthwise convolution layers is configured for independently extracting information from the respective plurality of input channels using a 3×3 kernel.

4. The method according to claim 1, wherein the depthwise separable neural convolutional network includes at least two pointwise convolution layers, and wherein:
a first pointwise convolution layer of the at least two pointwise convolution layers is configured for projecting an input of the depthwise separable neural convolution network into a higher-dimensional latent space, and
a second pointwise convolution layer of the at least two pointwise convolution layers is configured for projecting a second input, which includes a dimension of the higher-dimensional latent space, into a lower-dimensional latent space.

5. The method according to claim 4, wherein the second input includes an output of a depthwise convolution layer from the one or more depthwise convolution layers, and the second pointwise convolution layer is configured for performing a pointwise convolution in order to generate a linear combination of the output of the depthwise convolution layer.

6. The method according to claim 1, wherein the plurality of network layers further includes one or more activation layers, wherein each of the one or more activation layers includes a respective activation function, wherein each respective activation layer of the one or more activation layers is configured for performing an activation on an input of the respective activation layer, wherein the activation includes applying the respective activation function to the input, and wherein the method further comprises:
adapting each of one or more respective activation functions of the activation functions of the one or more activation layers to a respective adapted activation function, wherein each respective adapted activation functions differs from the respective activation function from the one or more activation functions of the one or more activation layers.

7. The method according to claim 6, wherein:
the one or more respective activation functions include non-parametric activation functions including a ReLU activation function or a ReLU activation function with an upper limit or a hardswish activation function or a sign activation function or a LeakyReLU activation function, and
the one or more respective adapted activation functions include parametric activation functions including a PReLU activation function.

8. The method according to claim 1, wherein each respective network layer in the plurality of network layers includes one or more input channels and one or more output channels, and wherein the quantizing of the plurality of network weights includes, for each output channel in the one or more output channels,
determining a scaling factor,
quantizing a network weight in the plurality of network weights by scaling the network weight using the determined scaling factor, and rounding the scaled network weight to a rounded value in a discrete range, wherein the discrete range is the first discrete range or the second discrete range.

9. The method according to claim 8, wherein the scaling factor for each output channel in the one or more output channels of the respective network layer is determined by one of:
a mean absolute value of the network weights of the output channel over the one or more input channels of the respective network layer, or
a maximum absolute value of the network weights of the output channel, or
a minimum absolute value of the network weights of the output channel, or
a uniform non-negative real value, independent of the network weights of the output channel.

10. A computer-implemented method for training a depthwise separable convolutional neural network (DSCNN), wherein the depthwise separable convolutional neural network includes a plurality of network layers, wherein each of the plurality of network layers includes a plurality of network weights, the plurality of network layers including:
one or more pointwise convolution layers, which are configured for performing pointwise convolutions, wherein each of the one or more pointwise convolution layers includes a plurality of pointwise convolution layer weights,
a depthwise convolution layer, which is suitable for performing depthwise convolutions, wherein each of the one or more depthwise convolution layers includes a plurality of depthwise convolution layer weights, and
one or more activation layers, wherein each of the one or more activation layers is suitable for performing an activation at an input of the particular activation layer,
the method comprising:
iteratively training the plurality of network weights on a training data set, wherein the training data set comprises a plurality of input samples, wherein the training for an input sample includes:
during a forward pass:
simulating a quantization step of the network layers using a quantization method, wherein the plurality of network weights are quantized to a plurality of quantized network weights,
quantizing activations of the input sample, which are performed by the one or more activation layers, to quantized activations in a discrete range,
dequantizing the plurality of quantized network weights and the quantized activations by rescaling the plurality of quantized network weights and rescaling the quantized activations, resulting in a plurality of dequantized network weights and dequantized activations,
during a backward pass, performing a gradient estimation using the dequantized network weights and the dequantized activation,
based on the gradient estimation, adapting the dequantized network weights and the dequantized activations,
providing the trained depthwise separable convolutional neural network for inference.

11. The method according to claim 10, wherein the quantizing method includes the following steps:
quantizing the plurality of pointwise convolution layer weights to a plurality of quantized pointwise convolution layer weights in a first discrete range; and
quantizing the plurality of depthwise convolution layer weights to a plurality of quantized depthwise convolution layer weights in a second discrete range;
wherein the first discrete range has a strictly lower cardinality than the second discrete range.

12. The method according to claim 11, further comprising:
before the providing of the trained depthwise separable neural convolutional network for inference, quantizing the plurality of network weights using the quantization method, resulting in a plurality of quantized network weights, and
maintaining the plurality of quantized network weights during inference.

13. A computer-implemented method, comprising:
using a depthwise separable convolutional neural network, on: (i) a device having limited computing resources and/or (ii) a mobile device and/or (iii) an autonomous device including an autonomous robot and/or an autonomous vehicle, for performing one or more of computer vision and/or object recognition and/or image processing and/or image recognition and/or image classification, medical imaging and/or image generation, wherein the depthwise separable convolutional neural network has been trained using a method for training the depthwise separable convolutional neural network, wherein the depthwise separable convolutional neural network includes a plurality of network layers, wherein each of the plurality of network layers includes a plurality of network weights, the plurality of network layers including:
one or more pointwise convolution layers, which are configured for performing pointwise convolutions, wherein each of the one or more pointwise convolution layers includes a plurality of pointwise convolution layer weights,
a depthwise convolution layer, which is suitable for performing depthwise convolutions, wherein each of the one or more depthwise convolution layers includes a plurality of depthwise convolution layer weights, and
one or more activation layers, wherein each of the one or more activation layers is suitable for performing an activation at an input of the particular activation layer,
the method comprising the following:
iteratively training the plurality of network weights on a training data set, wherein the training data set comprises a plurality of input samples, wherein the training for an input sample includes:
during a forward pass:
simulating a quantization step of the network layers using a quantization method, wherein the plurality of network weights are quantized to a plurality of quantized network weights,
quantizing activations of the input sample, which are performed by the one or more activation layers, to quantized activations in a discrete range,
dequantizing the plurality of quantized network weights and the quantized activations by rescaling the plurality of quantized network weights and rescaling the quantized activations, resulting in a plurality of dequantized network weights and dequantized activations,
during a backward pass, performing a gradient estimation using the dequantized network weights and the dequantized activation,
based on the gradient estimation, adapting the dequantized network weights and the dequantized activations,
providing the trained depthwise separable convolutional neural network for inference.

14. The method according to claim 13, wherein the depthwise separable convolutional neural network: (i) uses an image as input, and/or (ii) includes one or more models for computer vision and/or object recognition and/or image processing and/or image recognition and/or image classification and/or medical imaging and/or image generation and/or other image analysis applications.

15. A non-transitory computer-readable medium on which is stored data that represent a computer program, wherein the computer program comprises instructions for performing a computer-implemented quantization method for a depthwise separable convolutional neural network (DSCNN), wherein the depthwise separable convolutional neural network includes a plurality of network layers, wherein each of the plurality of network layers includes a plurality of network weights, the plurality of network layers including:
one or more pointwise convolution layers, which are configured for performing pointwise convolutions, wherein each of the one or more pointwise convolution layers includes a plurality of pointwise convolution layer weights, and
one or more depthwise convolution layers, which are configured for performing depthwise convolutions, wherein each of the one or more depthwise convolution layers includes a plurality of depthwise convolution layer weights,
the computer program, when executed by a processor system, causing the processor system to perform the following steps comprising:
quantizing the plurality of pointwise convolution layer weights to a plurality of quantized pointwise convolution layer weights in a first discrete range; and
quantizing the plurality of depthwise convolution layer weights to a plurality of quantized depthwise convolution layer weights in a second discrete range;
wherein the first discrete range has a strictly lower cardinality than the second discrete range.

16. A processor system, comprising:
a memory; and
one or more processors;
wherein the memory stores instructions that cause the one or more processors to perform a computer-implemented quantization method for a depthwise separable convolutional neural network (DSCNN), wherein the depthwise separable convolutional neural network includes a plurality of network layers, wherein each of the plurality of network layers includes a plurality of network weights, the plurality of network layers including:
one or more pointwise convolution layers, which are configured for performing pointwise convolutions, wherein each of the one or more pointwise convolution layers includes a plurality of pointwise convolution layer weights, and
one or more depthwise convolution layers, which are configured for performing depthwise convolutions, wherein each of the one or more depthwise convolution layers includes a plurality of depthwise convolution layer weights,
the quantization method comprising quantizing the plurality of network weights, including the following steps:
quantizing the plurality of pointwise convolution layer weights to a plurality of quantized pointwise convolution layer weights in a first discrete range; and
quantizing the plurality of depthwise convolution layer weights to a plurality of quantized depthwise convolution layer weights in a second discrete range;
wherein the first discrete range has a strictly lower cardinality than the second discrete range.
